(19) United States
(12) Patent Application Publication
(10) Pub. No.: US 2010/0198689 A1
(43) Pub. Date: Aug. 5, 2010

(54) METHOD, SYSTEM, OR APPRATUS FOR IMPLEMENTING A BUDGET BALANCED/SURPLUS SYNDICATED SPONSORED SEARCH MARKET

(75) Inventors: Rica Gonen, Sunnyvale, CA (US); Colin Brady, Sunnyvale, CA (US)

Correspondence Address: BERKELEY LAW & TECHNOLOGY GROUP LLP, 17933 NW EVERGREEN PARKWAY, SUITE 250, BEAVERTON, OR, 97006, US

(73) Assignee: Yahoo!, Inc., a Delaware corporation, Sunnyvale, CA (US)

(21) Appl. No.: 12/365,088

(22) Filed: Feb. 3, 2009

(51) Int. Cl. G06Q 30/00

(52) U.S. Cl. 705/14.54; 705/37

(57) ABSTRACT

Embodiments of methods, apparatuses, or systems relating to implementing a budget balanced/surplus syndicated sponsored search market.

### BACKGROUND

1. Field

The subject matter disclosed herein relates to a budget balanced/surplus syndicated sponsored search market.

2. Information

Sponsored search auctions represent one way that search providers monetize their search engines. Sponsored search allows advertisers and/or associated agents to bid on particular queries, thereby ensuring the relevance of an advertisement to a user, and increasing the conversion rate. Sponsored search is a significant business, projected to grow to many billions of dollars in the next few years.

Recently, a market for sponsored search auctions may be evolving into networks of advertisers and publishers. These markets, which may be termed syndicated sponsored search markets, may present particular concerns in contrast to more traditional sponsored search markets. For example, existing mechanisms and/or approaches useful for traditional sponsored search markets may produce, or result in, undesirable economic conditions for one or more market participants in a syndicated sponsored search market. Thus, other mechanisms and/or approaches may be desirable.

### BRIEF DESCRIPTION OF DRAWINGS

Subject matter is particularly pointed out and distinctly claimed in the concluding portion of the specification. Claimed subject matter, however, both as to organization and method of operation, together with objects, features, and advantages thereof, may best be understood by reference of the following detailed description if read with the accompanying drawings in which:

FIG. 1 is a flow chart depicting an embodiment of an exemplary method to implement a budget balanced/surplus syndicated sponsored search market.

FIG. 2 is a schematic diagram depicting an embodiment of an exemplary apparatus to implement a budget balanced/surplus syndicated sponsored search market.

FIG. 3 is a schematic diagram depicting an embodiment of an exemplary system to implement a budget balanced/surplus syndicated sponsored search market.

### DETAILED DESCRIPTION

In the following detailed description, numerous specific details are set forth to provide a thorough understanding of claimed subject matter. However, it will be understood by those skilled in the art that claimed subject matter may be practiced without these specific details. In other instances, methods, apparatuses or systems that would be known by one of ordinary skill have not been described in detail so as not to obscure claimed subject matter.

Reference throughout this specification to “one embodiment”, “an embodiment”, or “certain embodiments” may mean that a particular feature, structure, or characteristic described in connection with one or more particular embodiments may be included in at least one embodiment of claimed subject matter. Thus, appearances of the phrase “in one embodiment”, “an embodiment”, “certain embodiments”, or the like in various places throughout this specification are not necessarily intended to refer to the same embodiment or to any one particular embodiment described. Furthermore, it is to be understood that particular features, structures, or characteristics described may be combined in various ways in one or more embodiments. In general, of course, these and other issues may vary with the particular context. Therefore, the particular context of the description or the usage of these terms may provide helpful guidance regarding inferences to be drawn for that particular context.

Likewise, the terms, “and”, “and/or”, and “or” as used herein may include a variety of meanings that will depend at least in part upon the context in which it is used. Typically, “and/or” as well as “or” if used to associate a list, such as A, B or C, is intended to mean A, B, and C, here used in the inclusive sense, as well as A, B or C, here used in the exclusive sense. In addition, the term “one or more” as used herein may be used to describe any feature, structure, or characteristic in the singular or may be used to describe some combination of features, structures or characteristics. Though, it should be noted that this is merely an illustrative example and claimed subject matter is not limited to this example.

Some portions of the detailed description which follow are presented in terms of algorithms and/or symbolic representations of operations on data bits or binary digital signals stored within a computing system memory, such as a computer memory. These algorithmic descriptions and/or representations are the techniques used by those of ordinary skill in the data processing arts to convey the substance of their work to others skilled in the art. An algorithm is here, and generally, considered to be a self-consistent sequence of operations and/or similar processing leading to a desired result. The operations and/or processing involve physical manipulations of physical quantities. Typically, although not necessarily, these quantities may take the form of electrical and/or magnetic signals capable of being stored, transferred, combined, compared and/or otherwise manipulated. It has proven convenient, at times, principally for reasons of common usage, to refer to these signals as bits, data, values, elements, symbols, characters, terms, numbers, numerals, information, and/or the like. It should be understood, however, that all of these and similar terms are to be associated with the appropriate physical quantities and are merely convenient labels. Unless specifically stated otherwise, as apparent from the following discussion, it is appreciated that throughout this specification discussions utilizing terms such as “processing”, “computing”, “calculating”, “determining” and/or the like refer to the actions and/or processes of a computing platform, such as a computer or a similar electronic computing device, that manipulates and/or transforms data represented as physical electronic and/or magnetic quantities and/or other physical quantities within the computing platform's memories, registers, and/or other information storage, transmission, and/or display devices.

As mentioned previously, existing mechanisms and/or approaches useful for traditional sponsored search markets may produce, or result in, undesirable economic conditions for one or more market participants in a syndicated sponsored search market. Some of these concerns are discussed below. First, however, a brief discussion of a typical sponsored search auction is presented.

In general, sponsored search auctions have a simple framework. In a typical sponsored search auction, an advertiser specifies a query to advertise on, and submits a bid for that query, representing the maximum amount that advertiser is willing to pay. When a user enters a query, a sponsored search auction system collects the advertisers' bids for that query, and runs a generalized second price auction to determine which advertisers win and what prices each winner may be charged. Accordingly, there are usually multiple winners, as there are multiple slots for advertising on a search result page. Typically, higher slots tend to be more valuable since they may be seen by more users and/or may be more conspicuously displayed to a user viewing a displayed search results page. Finally, a winning advertiser is generally charged only in the event of a user click on their ad; otherwise no money may change hands. Charging in the event of user click has been termed a so-called “pay per click” scheme. In a sponsored search auction, where advertisements are typically presented alongside search results, it is generally a search engine that controls the placement of an advertisement and any reserve prices for advertisement slots.

Currently, however, some traditional sponsored search markets, such as the one previously described, may be evolving into a type of syndicated sponsored search market. For example, networks between advertisers and publishers appear to be forming and, with such networks, publishers may offer to place advertisements along their content pages. Thus, in a syndicated environment, publishers may act as advertising slot sellers. In contrast, in a typical sponsored search environment, a search engine general acts as an advertising slot seller. Accordingly, in a syndicated environment, a search engine may tend to occupy a different position than it did in a more traditional environment: that of a market maker.

A syndicated sponsored search market may present some unique concerns. One concern, for example, may be that publishers—not search engines—may set reserve prices for advertisement slots. Publishers, for example, may want to set reserve prices for advertisement as they encounter costs, such as a user satisfaction decrease, by placing advertisements with its content. Thus, a syndicated sponsored search market may have concerns relating to publishers truthfully reporting their costs. In addition, traditional mechanisms and/or approaches, such as a laddered auction for sponsored search, are believed by some to be inadequate and/or undesirable in a sponsored search environment. For example, in a syndicated sponsored search environment, a laddered auction may charge prices that may be below reserve prices for particular advertisement slots. Another concern, for example, may be that, if traditional mechanisms and/or approaches are utilized, a market maker in a syndicated sponsored search market may potentially sustain a budget deficit. As a search engine may be a market maker in a syndicated market, it may be unreasonable or undesirable to expect it to carry a loss.

With this and other concerns in mind, in accordance with certain aspects of the present description, example implementations may include methods, systems, or apparatuses for implementing a budget balanced/surplus syndicated sponsored search market. In an implementation, for example, a syndicated sponsored search market may be implemented that operates without a loss (i.e. budget balanced/surplus), while also maintaining desired properties of SNE (Symmetric Nash Equilibrium), individual rationality and minimal loss of efficiency.

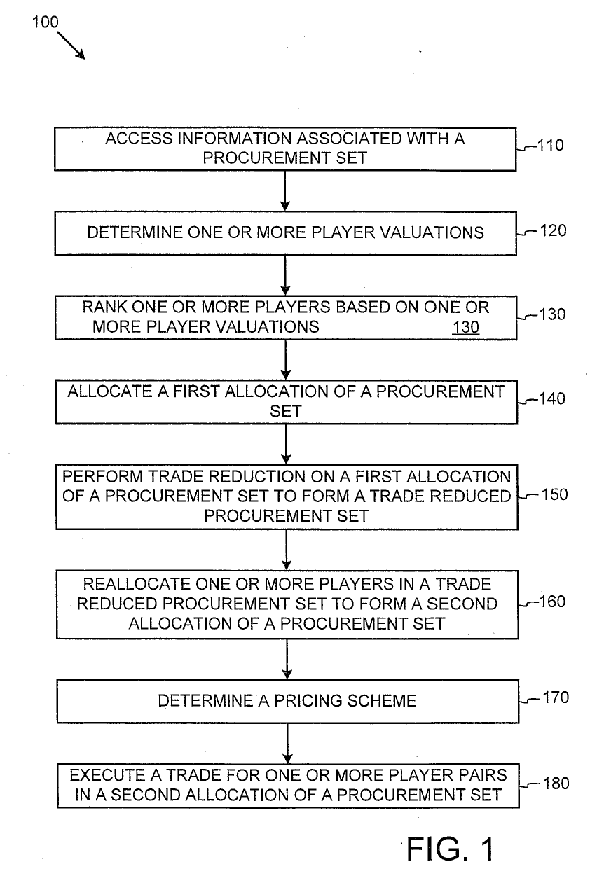

Attention is now drawn to FIG. 1, which is a flow chart depicting an exemplary embodiment of a method 100 that may be implemented to provide/support a budget balanced/surplus syndicated sponsored search market. At block 110 one or more processes may access information associated with a procurement set. In this context, a “procurement set” may be the minimum number of players for a trade to occur. For example, in an auction, such as a double-sided auction, a procurement set may include a pair of players, such as a buyer and a seller, or one or more buyers or one or more sellers. Players, such as buyer players (“buyers”) or seller players (“sellers”), or their respective agents, may be associated with a plurality of advertising slots. Thus, in an example implementation, a single buyer may have multiple bids for advertising slots in an auction. Correspondingly, a single seller may have multiple reserve prices for advertising slots in an auction.

Accordingly, information associated with a procurement set may include information relating to one or more buyers or sellers, such as bid information, valuation information, slot information, click-through rate information, reserve price information, cost information, and so on, as non-limiting examples. In certain example implementations, accessing information associated with a procurement set may include accessing a buyer's bid or a seller's slot cost.

At block 120, one or more process may determine one or more player valuations. For example, in an implementation, a buyer valuation may be determined by a function of values associated with a buyer, such as a buyer's bid, and values associated with a buyer's advertisement, such as a buyer's click-through rate, etc. To illustrate, let Vᵢ represent a value V associated with buyer i, and X represent a value X associated with a click-through rate of buyer i. Thus, in an implementation, a buyer valuation may be represented by value Vᵢ·Xᵢ. Similarly, in an implementation, a seller valuation may be determined by a function of values associated with a seller, such as values associated with a seller's slot cost and/or a click-through rate of a seller's slot. For example, a seller valuation for seller j may be a function of seller slot cost (e.g., a seller's reserve price for a particular slot), represented by Cⱼ, and a click-through rate of a seller's slot, represented by Yⱼ, such that a seller valuation may be represented by value Cⱼ·Yⱼ.

In addition, in certain implementations, one or more player valuations determined at block 120 may include valuations in which click-through rates are separable. Thus, in certain example implementations, click-through rates may be the product of a function of values associated with an advertiser's advertisement quality and a position in which an advertisement may appear. For example, for a buyer i and a seller slot j, λ_{i,j}=xᵢ·yⱼ where xᵢ is buyer i's click-through rate and yⱼ is slot j's click-through rate.

At block 130, one or more process may rank one or more players in a procurement set based, at least in part, on one or more player valuations. In certain implementations, one or more player valuations used for ranking at block 130 may be determined at block 120. While various ranking schemes may be utilized, in certain implementations, one or more buyer players may be ranked in substantially non-ascending (e.g., descending) rank based, at least in part, on a buyer's valuation. For example, one or more buyers may be ranked such that buyer i₁≧i₂≧iₙ . . . and so forth, where i₁ may be a buyer associated with a highest respective value. In contrast, in certain implementations, one or more seller players may be ranked in substantially non-descending (e.g., ascending) rank based, at least in part, on a seller's valuation. Thus, for example one or more sellers may be ranked such that seller j₁≦j₂≦j₃ and so forth, where j₁ may be associated with a lowest respective value.

Accordingly, in an implementation, a buyer associated with a highest respective value, i₁ may be ranked such that it may be paired with a seller associated with a lowest respective value j₁. In addition, in certain implementations, players may be ranked in a procurement set so that a buyer associated with a next highest respective value, such as i₂, may be ranked so that it may be paired with a seller associated with a next lowest respective value, such as j₂, and so on for a procurement set.

At block 140, one or more process may allocate a first allocation of a procurement set. For example, a first allocation of a procurement set may include determining which player pairings, such as buyer/seller pairing determined by ranking at block 130, may have a positive gain from trade. For example, in certain implementations, player pairing that may have a positive gain from trade may be player pairs where a buyer's value exceeds or may be equal to a seller's value. For example, in an implementation, a first allocation of a procurement set may determine that a first allocation may include those pairing such that Vᵢ·Xᵢ≧Cⱼ·Yⱼ. Alternatively and/or additionally, at block 140, one or more process may determine which player pairings may have a loss from trade, such as player pairs where Vᵢ·Xᵢ<Cⱼ·Yⱼ. In an example implementation, player pairs which may have a loss from trade may be removed from a procurement set at block 140.

In certain example implementations, a first allocation of a procurement set, such as may be allocated at block 140, may be an efficient allocation. For example, an efficient allocation may be an allocation of a procurement set where all player pairs in a procurement set may be capable of having a positive gain from trade. As suggested previously, however, if trades in an efficient allocation of a procurement set were to be executed, current research suggests that, where certain conditions such as individually rationality and incentive compatibility are maintained, such a market will likely run a deficit performance (e.g., will not be budget balanced). Accordingly, in an implementation, a trade reduction may occur that may otherwise have an effect of compromising some efficiency, and/or one or more other properties, to achieve a market capable of producing a budget balance and/or budget surplus.

At block 150, one or more process may perform trade reduction to form a trade reduced procurement set. Here, a variety of trade reduction techniques may be utilized and claimed subject matter is not to be limited to a particular technique. For example, one technique that may be utilized may be a trade reduction approach first suggested by R. Preston McAfee in a work entitled “A Dominant Strategy Double Auction.” (“McAfee approach”) See, Journal of Economic Theory, Volume 56, pages 434-450, 1992. To illustrate a McAfee approach, suppose an efficient allocation of a procurement set exists such as previously described. In the McAfee approach, trade reduction is performed by removing a last trading pair in an efficient allocation. That is, the last player pair in an efficient allocation of a procurement set capable of having a positive gain from a trade is removed.

Of course, as mentioned above, the McAfee approach is merely one technique for trade reduction. Some believe that the McAfee approach may give up more efficiency than desired to achieve a market capable of producing a balance budget/surplus. Accordingly, various other trade reduction schemes exist, or may be devised, which may be utilized by one or more process at block 150. For example, another trade reduction approach, known as generalized trade reduction, may be utilized at block 150. Generalized trade reduction makes use of internal and/or external competition to determine which player(s) may be removed from a procurement set. A more detailed description of a generalized trade reduction approach may be found in U.S. patent application Ser. No. 11/881,694 entitled “System and Method of Making Trading Markets Using Generalized Trade Reduction.”

An illustrative implementation of a trade reduction approach may be as follows: assume an efficient allocation of a procurement set for a syndicator double-sided auction has a set of buyers with valuations Vᵢ·Xᵢ and a set of sellers with valuations Cⱼ·Yⱼ. A trade reduction approach may be to remove a buyer in the procurement set such that Vᵢ·Xᵢ is minimal. Correspondingly, a seller may be unmatched in the procurement set such that Cⱼ·Yⱼ is maximal. Accordingly, in an implementation, the remaining players in this procurement set may be referred to as a trade reduced procurement set.

At block 160, one or more process may reallocate one or more players in a trade reduced procurement set to form a second allocation of a procurement set. In an implementation, reallocating one or more players in a trade reduced procurement set may include re-ranking seller players in a trade reduced procurement set in non-ascending (e.g., descending) rank. For example, as mentioned previously, in an implementation, one or more seller players in a first allocation of a procurement set, or in a trade reduced procurement set, may be ranked in substantially non-descending (e.g., ascending) rank based on valuation. For example, sellers may be ranked such that seller j₁≧j₂≦j₃ and so forth, where j₁ may be a seller associated with a lowest respective value. Thus, here, in an example implementation, sellers may be re-ranked so that j₁≧j₂≅j₃ and so forth, where j₁ may be a seller with a highest respective value. Accordingly, in an implementation, a second allocation of a procurement set may be a trade reduced procurement set where buyers and sellers may both be ranked by valuation in non-ascending (e.g., descending) rank.

At block 160, one or more process may match one or more buyers and/or one or more sellers in a second allocation of a procurement set to form player pairs. For example, an in embodiment, a buyer associated with a highest respective value i₁ may be matched with a seller associated with a highest respective value j₁. In certain example implementations, one or more player pairs may be matched in second allocation of a procurement set so that a buyer associated with a next highest respective value, such as i₂, may be matched with a seller associated with a next highest respective value, such as j₂, and so on.

At block 170, one or more process may determine a pricing scheme. For example, a pricing scheme may be determined for one or more player pairs in a second allocation of a procurement set. While a variety of pricing schemes may be utilized, in certain implementations, a pricing scheme for one or more player pairs in a second allocation may be determined by a player's pairing in a first allocation of a procurement set. In an example implementation, a buyer i may be charged a price P such that ipᵢ=max {bᵢ₊₁, cₑ₍ᵢ₎}, where cₑ₍ᵢ₎ is a seller slot cost matched with buyer i in a first allocation of a procurement set. Similarly, a seller for slot j may be charged a price P such that jpⱼ=bₑ₍ⱼ₎, where bₑ₍ⱼ₎ is the bid of a buyer paired with a seller for slot j in a first allocation of a procurement set.

At block 180, one or more process may execute a trade for one or more player pairs in a second allocation of a procurement set. In an example implementation, at block 180, one or more buyers may be charged prices determined at block 170. Similarly, in an implementation, one or more sellers may be charged prices determined at block 170. Thus, in an implementation, a winning buyer's advertisement may be displayed in a corresponding advertisement slot of a seller, and a buyer may be charged if its advertisement is clicked by a user, such as in a pay-per-click scheme mentioned previously.

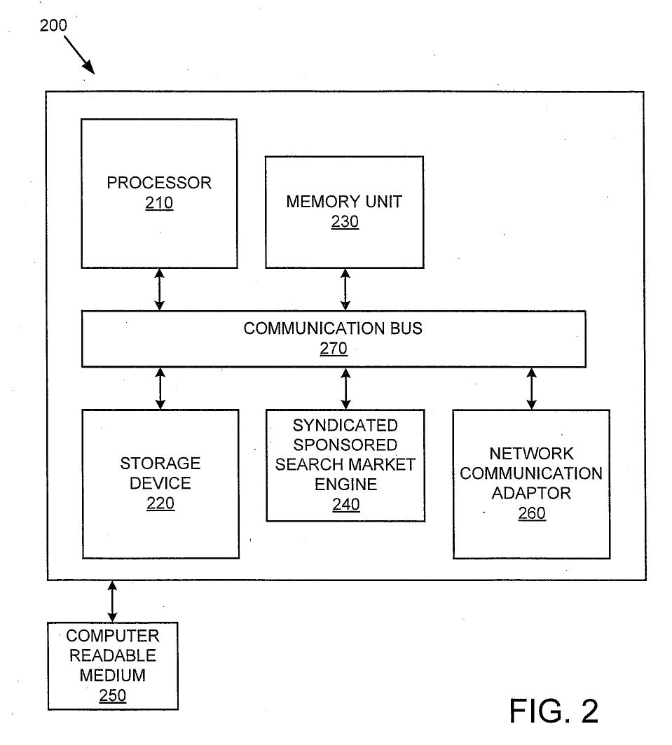

FIG. 2 is a schematic diagram depicting embodiment of an exemplary apparatus 200 to implement a budget balanced/surplus syndicated sponsored search market. Here, apparatus 200 may include a special purpose computing platform, and/or the like. In this context, the phrase “special purpose computing platform” means or refers to a computing platform once it is programmed to perform particular functions pursuant to instructions from program software. Here, apparatus 200 depicts a special purpose computing platform that may include one or more processors, such as processor 210. Furthermore, apparatus 200 may include one or more memory devices, such as storage device 220, memory unit 230, syndicated sponsored search market engine 240 or computer readable medium 250. In addition, apparatus 200 may include one or more network communication adapters, such as network communication adaptor 260. Apparatus 200 may also include a communication bus, such as communication bus 270, operable to allow one or more connected components to communicate under appropriate circumstances.

In an example embodiment, communication adapter 260 may be operable to receive information associated with one or more players in a procurement set, such as one or more buyer bids and/or seller slot costs. In addition, as non-limiting examples, communication adapter 260 may be operable to send or receive one or more signals corresponding to information associated with one or more players in a procurement set, or it may be operable to send or receive one or more signals corresponding to information relating to an execution of one or more trades, to one or more computing platforms (not depicted).

In an example embodiment, syndicated sponsored search market engine 240 may be operable to perform one or more processes previously described, such as one or more process depicted in FIG. 1. For example, syndicated sponsored search market engine 240 may by operable to access information associated with a procurement set, determine valuations, rank and match players, perform allocations and trade reduction, determine a pricing scheme, or execute a trade as non-limiting examples.

In certain embodiments, apparatus 200 may be operable to transmit or receive information relating to, or used by, one or more process or operations via communication adapter 260, computer readable medium 250, and/or have stored some or all of such information on storage device 220, for example. As an example, computer readable medium 250 may include some form of volatile and/or nonvolatile, removable/non-removable memory, such as an optical or magnetic disk drive, a digital versatile disk, magnetic tape, flash memory, or the like. In certain embodiments, computer readable medium 250 may have stored there on computer-readable instructions, executable code, and/or other data which may enable a computing platform to perform one or more processes or operations mentioned previously.

In certain example embodiments, apparatus 200 may be operable to store information relating to, or used by, one or more operations mentioned previously, such as information relating to one or more procurement sets, in memory unit 230 and/or storage device 220. It should, however, be noted that these are merely illustrative examples and that claimed subject matter is not limited in this regard. For example, information stored or processed, or operations performed, in apparatus 200 may be performed by other components or devices depicted or not depicted in FIG. 2. Operations performed by syndicated sponsored search result engine 240 may be performed by processor 210 in certain embodiments. Operations performed by components or devices in apparatus 200 may be performed in distributed computing environments where one or more operations may be performed by remote processing devices which may be linked via a communication network.

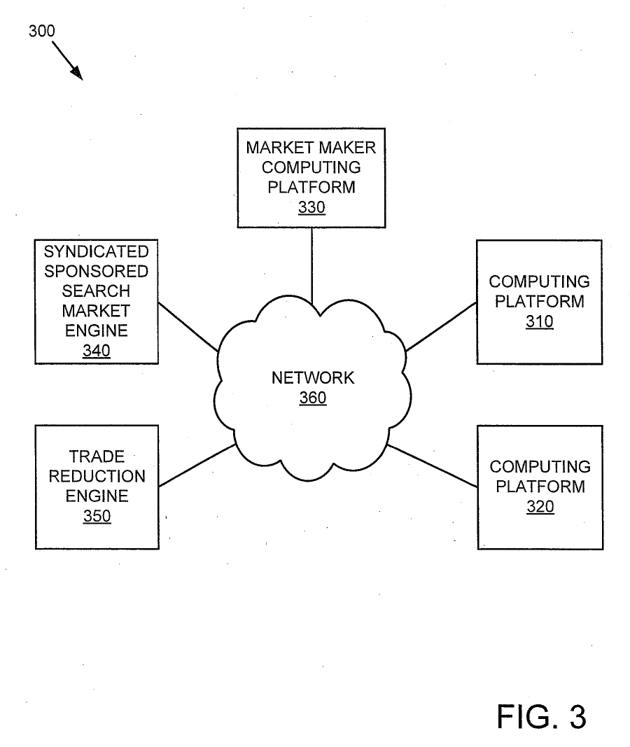

FIG. 3 is a schematic diagram depicting an embodiment of an exemplary system 300 that may be enabled to implement a budget balanced/surplus syndicated sponsored search market. In system 300, a computing platform 310 may be communicatively coupled to a network 360. Here, in this example, computing platform 310 may be a computing platform associated with one or more buyers. Thus, for example, a buyer may submit a bid, as a non-limiting example, that may be transmitted via computing platform 310 and network 360. A computing platform 320 may also be communicatively coupled to network 360. Here, for example, computing platform 320 may be associated with one or more publishers, such as a seller of advertisement slots. Thus, for example, a publisher may submit a price, as a non-limiting example, that may be transmitted via computing platform 320 and network 360.

System 300 may also include a market maker computing platform 330. Market maker computing platform 330, which may be associated with a search engine, for example, may be communicatively coupled to network 360. Market maker computing platform 330, in this example, may receive one or more bids or prices from computing platform 310 or computing platform 320, respectively, via network 360. In certain embodiments, market maker computing platform 330 may access or have stored thereon information relating to one or more players in a procurement set, or other information, such as bid information, valuation information, slot information, click-through rate information, reserve price information, cost information, or other information associated with a syndicated sponsored search market, as non-limiting examples. Market maker computing platform 330 may transmit information to, or receive information from, one or more computing platforms communicatively coupled to network 360, such as syndicated sponsored search engine 340 or trade reduction engine 350, for example.

In certain embodiments, market maker computing platform 330 may transmit information via network 360 to syndicated sponsored search engine 340 which may perform one or more process or operations to implement a budget balanced/surplus syndicated sponsored search market. For example, syndicated sponsored search engine 340 may receive information enabling it to determine valuations, rank and match players, perform allocations, determine a pricing scheme, or execute a trade as non-limiting examples. Accordingly, in this example, syndicated sponsored search market engine 340 may be capable of storing or transmitting results and/or information associated with one or more operations via network 360.

System 300 may also include a trade reduction engine 350, which may be communicatively coupled to network 360. In certain embodiments, trade reduction engine may be operable to perform trade reduction, such as described herein, by receiving appropriate information from one or more computing platforms communicatively coupled to network 360. Thus, in an embodiment, syndicated sponsored search market engine 340 may transmit appropriate information to trade reduction engine 350 via network 360, which may enable trade reduction engine 350 to perform trade reduction. Accordingly, trade reduction engine 350 may be capable of storing or transmitting results and/or information associated with one or more operations via network 360.

In certain embodiments, market maker computing platform 330 may receive information from one or more computing platforms via network 360, such as syndicated sponsored search market engine 340 and/or trade reduction engine 350, which may enable it to execute one or more trades.

Certain implementations and/or embodiments may have a variety of advantages. In an embodiment, for example, a syndicator sponsored market that is capable of being budget balanced, SNE, and individually rational may be implemented. For example, a market may be individually rational since, in an embodiment, a buyer's price may be less than the buyer's bid, (e.g., max {bᵢ₊₁, cₑ₍ᵢ₎} ≦bᵢ). Similarly, in an embodiment, a market may be individually rational for a seller since bₑ₍ⱼ₎≧cⱼ for a j.

In addition, another advantage of an embodiment may be that a syndicator sponsored search market that is capable of being SNE may be implemented. For example, a pricing scheme for a buyer in a second allocation of a procurement set in an embodiment is identical to an efficient pricing scheme in SNE in a first allocation of a procurement set. In addition, in an embodiment, a buyer may not have any (or may have less) incentive to move in rankings since all of the allocated buyers after a trade reduction did not change their relative ranking. Similarly, in an embodiment, for every slot that is allocated, a seller may be paid the truthful price from an efficient allocation. Accordingly, a seller may have no (or less) incentive to deviate from a truthful strategy.

Yet another advantage of an embodiment may be that a syndicator sponsored search market that is capable of being budget balanced may be implemented. For example, in an embodiment, buyers in a second allocation of a procurement set may be shifted down, such as by trade reduction, so that a buyer i may be matched with seller j in an efficient allocation. In this instance, in an embodiment a buyer i's price may be pᵢ=max {bᵢ₊₁, c₍ᵢ₎} and a seller for slot j may be paid pⱼ=bᵢ₊₁. Accordingly, pⱼ≦pⱼ₊₁ ensuring a budget balance.

In the preceding description, various aspects of claimed subject matter have been described. For purposes of explanation, specific numbers, systems and/or configurations were set forth to provide a thorough understanding of claimed subject matter. However, it should be apparent to one skilled in the art having the benefit of this disclosure that claimed subject matter may be practiced without the specific details. In other instances, features that would be understood by one of ordinary skill were omitted or simplified so as not to obscure claimed subject matter. While certain features have been illustrated or described herein, many modifications, substitutions, changes or equivalents will now occur to those skilled in the art. It is, therefore, to be understood that the appended claims are intended to cover all such modifications or changes as fall within the true spirit of claimed subject matter.

1. A method comprising:
accessing binary digital signals stored within a computing system memory, said binary digital signals representing information associated with a first allocation of a procurement set for a syndicator sponsored search auction, wherein
said first allocation of a procurement set comprises a trade reduced procurement set; further comprising reallocating one or more players in said trade reduced procurement set to form a second allocation of a procurement set, wherein at least a plurality of players in said second allocation of a procurement set are in non-ascending rank.

2. The method of claim 1, further comprising, prior to said accessing, allocating said first allocation of a procurement set.

3. The method of claim 2, wherein said allocating said first allocation of a procurement set further comprises determining one or more player valuations.

4. The method of claim 3, wherein said determining one or more player valuations comprises determining one or more buyer player valuations such that a buyer's valuation equals Vᵢ·Xᵢ; further comprising determining one or more seller player valuations such that a seller's valuation equals Cⱼ·Yⱼ.

5. The method of claim 3, further comprising ranking a plurality of players based, at least in part, on said one or more player valuations; wherein ranking a plurality of players based, at least in part, on said one or more player valuations further comprises ranking a plurality of players in non-ascending rank based, at least in part, on that buyer's valuation; or ranking a plurality of seller players in non-descending rank based, at least in part, on that seller's valuation.

6. The method of claim 1, wherein said first allocation of a procurement set comprises an efficient allocation.

7. The method of claim 1, further comprising, prior to said accessing, performing trade reduction on said first allocation of a procurement set to form said trade reduced procurement set.

8. The method of claim 7, wherein said performing trade reduction on said first allocation of a procurement set to form said trade reduced procurement set comprises removing a buyer such that Vᵢ·Xᵢ is minimal; further comprising unmatching a seller such that Cⱼ·Yⱼ is maximal.

9. The method of claim 7, wherein said performing trade reduction on said first allocation of a procurement set to form said trade reduced procurement set comprises performing generalized trade reduction.

10. The method of claim 1, wherein said reallocating one or more players in said trade reduced procurement set to form a second allocation of a procurement set comprises re-ranking a plurality of seller players in said trade reduced procurement set in non-ascending rank.

11. The method of claim 1, further comprising determining a pricing scheme for one or more players in said second allocation of a procurement set.

12. The method of claim 11, wherein said determining a pricing scheme for one or more players in said second allocation of a procurement set comprises determining a price for one or more buyer players such that ipᵢ=max {bᵢ₊₁, cₑ₍ᵢ₎}.

13. The method of claim 11, wherein said determining a pricing scheme for one or more players in said second allocation of a procurement set comprises determining a price for one or more seller players such that jpⱼ=bₑ₍ⱼ₎.

14. The method of claim 1, further comprising executing a trade for said one or more players pairs matched in said second allocation of a procurement set.

15. An apparatus, comprising:
a syndicated sponsored search market engine; wherein said syndicated sponsored search market engine is operatively enabled to reallocate one or more players in a trade reduced procurement set to form a second allocation of a procurement set, wherein a pricing scheme applied to one or more players in said second allocation of a procurement set is based, at least in part, on player pairing in a first allocation of said procurement set.

16. The apparatus of claim 15, wherein said syndicated sponsored search market engine is operatively enabled to implement a budget balanced/surplus, individually rational, SNE, mechanism for a procurement set of players in a syndicated sponsored search market.

17. The apparatus of claim 15, wherein said syndicated sponsored search market engine is communicatively coupled to a network of computing platforms.

18. The apparatus of claim 15, wherein said syndicated sponsored search market engine is operatively coupled to a trade reduction engine; wherein said trade reduction engine is operatively enabled to perform trade reduction on said first allocation of said procurement set.

19. The apparatus of claim 15, wherein said syndicated sponsored search market engine is operatively coupled to one or more storage devices; wherein said one or more storage devices are capable of storing one or more procurement sets.

20. An article, comprising:
a storage medium having instructions stored thereon; said storage medium, if said instructions are executed, further instructing a computing platform to access information associated with a first allocation of a procurement set for a syndicator sponsored search auction, wherein said first allocation of a procurement set comprises a trade reduced procurement set; further instructing said computing platform to reallocate one or more players in said trade reduced procurement set to form a second allocation of a procurement set, wherein said second allocation of a procurement set comprises one or more matched player pairs with a plurality of players being in non-ascending rank.
